(19) United States
(12) Patent Application Publication
(10) Pub. No.: US 2019/0349978 A1
(43) Pub. Date: Nov. 14, 2019

(54) Physical Resource Block Scaling For Data Channel With HARQ Process

(71) Applicant: MediaTek Inc., Hsinchu City (TW)

(72) Inventors: Kuhn-Chang Lin, Hsinchu City (TW); Gilles Charbit, Cambridge (GB)

(21) Appl. No.: 16/403,752

(22) Filed: May 6, 2019

Related U.S. Application Data
(60) Provisional application No. 62/669,408, filed on May 10, 2018.
(60) Provisional application No. 62/677,328, filed on May 29, 2018.

(51) Int. Cl. H04W 72/12; H04L 1/18; H04W 76/27; H04L 1/00; H04W 72/04

(52) U.S. Cl. CPC H04W 72/1289; H04L 1/1812; H04W 72/0446; H04L 1/0003; H04W 76/27

(57) ABSTRACT

Techniques and examples of physical resource block (PRB) scaling for data channel with a hybrid automatic repeat request (HARQ) process in mobile communications are described. An apparatus receives radio resource control (RRC) signaling from a wireless network indicating a PRB scaling factor. The apparatus also receives a downlink control command from the wireless network indicating whether PRB scaling is enabled or disabled. The apparatus then determines a transport block size (TBS) by either: (a) determining the TBS based on the PRB scaling factor and a scheduled physical downlink shared channel (PDSCH) PRB number indicated in the downlink control command responsive to the PRB scaling being enabled, or (b) determining the TBS based on the schedule PDSCH PRB number responsive to the PRB scaling being disabled. The apparatus also receives a PDSCH according to a result of the determining of the TBS.

### CROSS REFERENCE TO RELATED PATENT APPLICATION

The present disclosure claims the priority benefit of U.S. Provisional Patent Application Nos. 62/669,408 and 62/677,328, filed on 10 May 2018 and 29 May 2018, respectively. The contents of aforementioned applications are herein incorporated by reference in their entirety.

### TECHNICAL FIELD

The present disclosure is generally related to mobile communications and, more particularly, to physical resource block (PRB) scaling for data channel with a hybrid automatic repeat request (HARQ) process in mobile communications.

### BACKGROUND

Unless otherwise indicated herein, approaches described in this section are not prior art to the claims listed below and are not admitted as prior art by inclusion in this section.

In mobile communications such as in 5th Generation (5G) New Radio (NR) mobile communications, PRB scaling can be used to maintain effective code rate for special subframe, subframe with high reference signal (RS) overhead and/or large control format indicator (CFI). That is, when RS overhead and CFI value become larger, less available resource elements (REs) can be expected. There is no change on physical downlink shared channel (PDSCH)-occupied RE number. PDSCH transport block size (TBS) can be determined based on PRB size, modulation coding scheme (MCS) and layer number. Given a fixed TBS determination value, larger overhead also means higher code rate. However, under current 3rd-Generation Partnership Project (3GPP) specification, there remain some issues not yet addressed with respect to PRB scaling. For instance, there is an issue regarding how to maintain same TBS for retransmission (reTX) in a HARQ process if scaling factor depends upon current subframe overhead. Additionally, there is also an issue regarding how to deal with missing physical downlink control channel (PDCCH) of initial transmission if downlink control information (DCI) of reTX is not self-contained. Moreover, under current 3GPP specification, a base station (e.g., gNB) can enable and disable PRB scaling for PDSCH via DCI. However, there is an issue regarding the MCS indices with PRB scaling on 6-bit MCS table.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of an apparatus receiving radio resource control (RRC) signaling from a wireless network indicating PRB scaling factor. The method may also involve the processor receiving a downlink control command from the wireless network indicating whether PRB scaling is enabled or disabled. The method may further involve the processor determining a transport block size (TBS) by either: (a) determining the TBS based on the PRB scaling factor and a scheduled PDSCH PRB number indicated in the downlink control command responsive to the PRB scaling being enabled, or (b) determining the TBS based on the schedule PDSCH PRB number responsive to the PRB scaling being disabled. The method may additionally involve the processor receiving a PDSCH according to a result of the determining of the TBS.

In one aspect, a method may involve a processor of an apparatus receiving from a wireless network an MCS index indicating PRB scaling. The method may also involve the processor determining a TBS by choosing a first TBS index.

In one aspect, an apparatus may include a transceiver and a processor coupled to the transceiver. During operation, the transceiver may wirelessly communicate with a wireless network. During operation, the processor may perform the following operations: (1) receiving, via the transceiver, RRC signaling from the wireless network indicating a PRB scaling factor; (2) receiving, via the transceiver, a downlink control command from the wireless network indicating whether PRB scaling is enabled or disabled; (3) determining a TBS by either: (a) determining the TBS based on the PRB scaling factor and a scheduled PDSCH PRB number indicated in the downlink control command responsive to the PRB scaling being enabled, or (b) determining the TBS based on the schedule PDSCH PRB number responsive to the PRB scaling being disabled; and (4) receiving, via the transceiver, a PDSCH according to a result of the determining of the TBS.

It is noteworthy that, although description provided herein may be in the context of certain radio access technologies, networks and network topologies such as 5G/NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, and Internet-of-Things (IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example scenario in which various solutions in accordance with the present disclosure may be implemented.

FIG. 2 is a diagram of an example algorithm in accordance with an implementation of the present disclosure.

FIG. 3A shows a table of an example scenario of implementation of a proposed scheme in accordance with the present disclosure.

FIG. 3B shows a table of an example scenario of implementation of a proposed scheme in accordance with the present disclosure.

FIG. 3C shows a table of an example scenario of implementation of a proposed scheme in accordance with the present disclosure.

FIG. 4 is a block diagram of an example system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

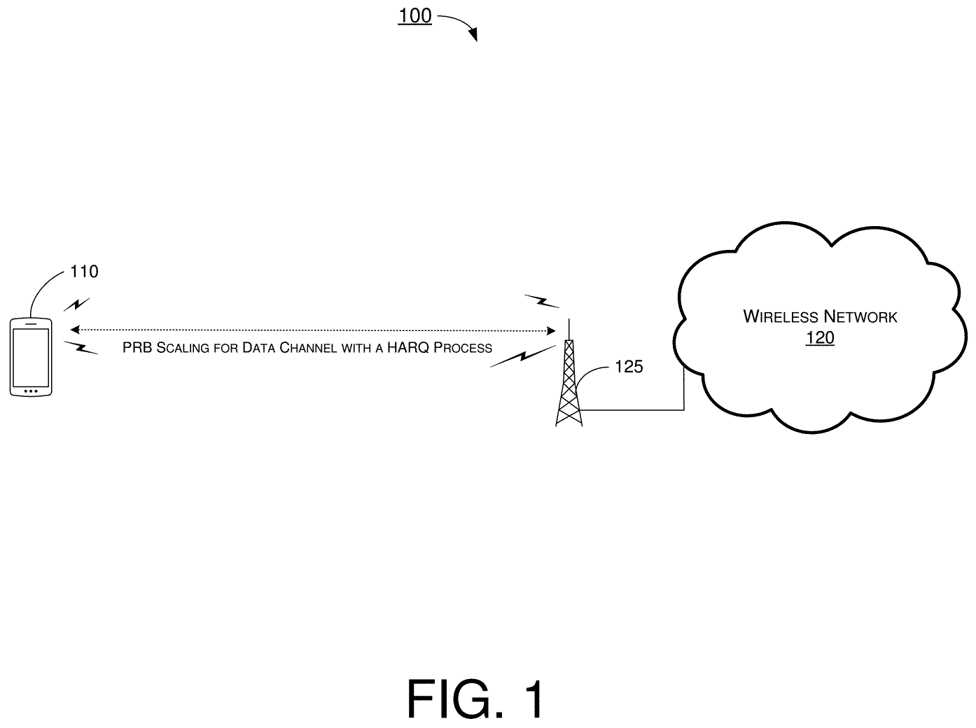

FIG. 1 illustrates an example scenario 100 in which various solutions in accordance with the present disclosure may be implemented. Referring to FIG. 1, scenario 100 may involve a UE 110 in wireless communication with a wireless network 120 (e.g., a 5G NR mobile network) via a base station 125 (e.g., an eNB, gNB or transmit-receive point (TRP)). In scenario 100, UE 110 may be in wireless communication with wireless network 120 via base station 125 to perform PRB scaling for data channel with a HARQ process in accordance with various solutions, schemes, concepts and/or designs with respect to the present disclosure, as described below.

Under a proposed scheme with respect to PRB scaling for data channel with a HARQ process, in downlink (DL) data reception and transmission, TBS size may depend on enabling and disabling of PRB scaling bit field(s) in DCI. For instance, in an event that PRB scaling is enabled, TBS determination may involve considering PRB scaling factor, which may be indicated in radio resource control (RRC) signaling. In an event that PRB scaling is disabled, TBS determination may be based on scheduled PDSCH PRB number signaled in DCI.

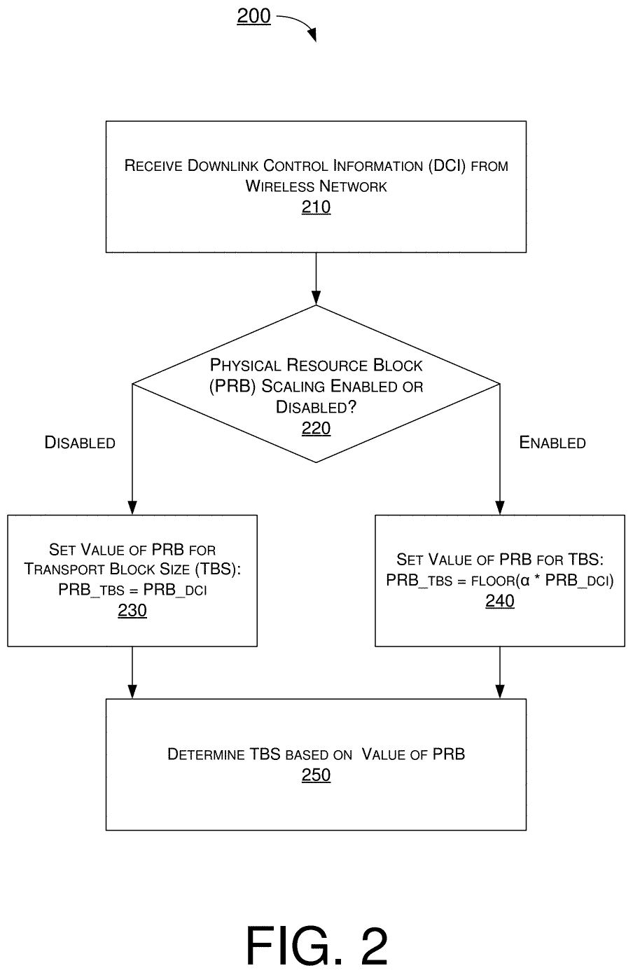

FIG. 2 illustrates an example algorithm 200 regarding PRB scaling for data channel with HARQ process in accordance with an implementation of the present disclosure. Algorithm 200 may include one or more operations, actions, or functions as represented by one or more of blocks 210, 220, 230, 240 and 250. Although illustrated as discrete blocks, various blocks of algorithm 200 may be divided into additional blocks, combined into fewer blocks, or eliminated, depending on the desired implementation. Algorithm 200 may be implemented by a UE (e.g., UE 110) in wireless communication with a wireless network (e.g., wireless network 120) in accordance with the present disclosure. Algorithm 200 may begin at 210.

At 210, algorithm 200 may involve UE 110 receiving DCI from wireless network 120 via base station 125. Algorithm 200 may proceed from 210 to 220.

At 220, algorithm 200 may involve UE 110 determining whether PRB scaling is enabled based on PRB scaling bit field(s) in the DCI. In an event that the determination by UE 110 indicates PRB scaling is disabled, algorithm 200 may proceed from 220 to 230. In an event that the determination by UE 110 indicates PRB scaling is enabled, algorithm 200 may proceed from 220 to 240.

At 230, algorithm 200 may involve UE 110 setting the value of PRB for TBS (herein denoted by the parameter “PRB_tbs”) based on the following expression: PRB_tbs=PRB_dci. Here, the parameter “PRB_dci” denotes a scheduled PRB number for PDSCH in DCI. Algorithm 200 may proceed from 230 to 250.

At 240, algorithm 200 may involve UE 110 setting the value of PRB_tbs based on the following expression: PRB_tbs=floor(α*PRB_dci). Here, the parameter “α” denotes a PRB scaling factor, which may depend on special subframe configuration, RS overhead and/or CFI values. Algorithm 200 may proceed from 240 to 250.

At 250, algorithm 200 may involve UE 110 determining TBS based on the value of PRB_tbs. For instance, UE 110 may utilize a lookup table in determining the TBS based on the following expression: TBS=LookUpTable (N_{PRB}, layer number from dci, QAM)]. Here, QAM stands for quadrature amplitude modulation.

For illustrative purposes on how proposed schemes in accordance with the present disclosure may be implemented to address aforementioned issues, an example of each of the aforementioned two issues and corresponding proposed solutions is described below assuming a cell bandwidth is 50 PRB.

In an example scenario with respect to the issue regarding how to maintain same TBS for retransmission in a HARQ process if scaling factor depends upon current subframe overhead, an initial transmission may involve the following parameters: MCS=15, light RS overhead with PRB scaling factor=0.875, PRB_dci=50, PRB_tbs=floor(50*0.875)=43, and TBS=12960. In this example scenario, a retransmission may involve the following parameters: MCS=15, medium RS overhead with PRB scaling factor=0.75, maximum PRB_dci=50, maximum PRB_tbs=floor(50*0.75)=37, and maximum TBS=11448. Here, the maximum TBS of retransmission is 11448 and less than 12960. Accordingly, in this example scenario, it is not possible to make the TBS of the retransmission to be the same as that of the TBS of the initial transmission.

In an example scenario with respect to the issue regarding how to deal with missing PDCCH of initial transmission if DCI of retransmission is not self-contained (e.g., forcing the TBS of retransmission to be the same as the TBS of initial transmission), the initial transmission may involve the following parameters: MCS=unknown, PRB_dci=unknown, PRB_tbs=unknown, and TBS=unknown. In this example scenario, the retransmission may involve the following parameters: MCS=15, medium RS overhead with PRB scaling factor=0.75, PRB_dci=50, and TBS=TBS of initial transmission, which is unknown. Accordingly, in this example scenario, DCI of retransmission becomes not self-contained and the corresponding TBS is floating.

Under a proposed scheme in accordance with the present disclosure, to address the two aforementioned issues, an additional one-bit field may be introduced in the DCI to indicate whether PRB scaling is enabled or disabled. In an event that PRB scaling is disabled, PRB_tbs may be set to equal to PRB_dci (e.g., PRB_tbs=PRB_dci). On the other hand, PRB scaling factor may be set to 1. For the issue regarding how to maintain same TBS for retransmission in a HARQ process if scaling factor depends upon current subframe overhead, by proper setting, the TBS of retransmission may be the same as the TBS of initial transmission. For the issue regarding how to deal with missing PDCCH of initial transmission if DCI of retransmission is not self-contained, DCI of retransmission may be self-contained.

For instance, an initial transmission may involve the following parameters: MCS=15, PRB scaling being enabled, light RS overhead with PRB scaling factor=0.875, PRB_dci=50, PRB_tbs=floor(0.875*50)=43, and TBS=12960. The retransmission may involve the following parameters: MCS=15, PRB scaling being disabled, PRB_dci=43, PRB_tbs=1*PRB_dci=43, and TBS=12960. Advantageously, the TBS of the retransmission may be the same as the TBS of the initial transmission.

Under a proposed scheme in accordance with the present disclosure, PRB scaling design may involve several steps or stages. In a first step, PRB scaling factor α may be set to 1 in an event that PRB scaling is disabled. In a second step, available number of resource elements for PDSCH data transmission (herein denoted as “Avail_RE”) may be calculated. For instance, Avail_RE may be calculated based on PRB allocation in DCI. Moreover, cell-specific reference signals (CRS), control region with control format indicator (CFI)>1, demodulation reference signals (DMRS), channel state information reference signals (CSI-RS) and enhanced physical downlink control channel (ePDCCH) may be excluded. In a third step, the number of all resource elements for PDSCH data transmission (herein denoted as “All_RE”) may be calculated. For instance, All_RE may be calculated based on PRB allocation in DCI. Moreover, CRS and DMRS may be excluded. In a fourth step, a ratio (r) of Avail_RE over All_RE may be derived or otherwise calculated. In a fifth step, the PRB scaling factor α may be determined. As an illustrative example, a may be determined as follows:

$$\begin{matrix}if ( r < ( 4.5 / 8 = 0.5625 ) ) , & α = 4 / 8 = 0.5 ; \\ else if ( r < ( 5.5 / 8 = 0.6875 ) ) , & α = 5 / 8 = 0.625 ; \\ else if ( r < ( 6.5 / 8 = 0.8125 ) ) , & α = 6 / 8 = 0.75 ; \\ else if ( r < ( 7.5 / 8 = 0.9375 ) ) , & α = 7 / 8 = 0.875 ; \\ else & α = 8 / 8 = 1.\end{matrix}$$

Under a proposed scheme in accordance with the present disclosure, a PRB scaling procedure may involve UE 110 performing some operations. For instance, UE 110 may determine whether PRB scaling is disabled. In an event that PRB scaling is disabled, UE 110 may set PRB scaling factor to 1. Otherwise, in an event that PRB scaling is enabled, based on predefined RS and DCI overhead UE 110 may determine a channel quality indicator (001) index by using CFI value and RS overhead at a subframe n. Assuming a reported spectrum efficiency (SE) per available RE is X, UE 110 may report SE=X at subframe n+k. When wireless network 120 decides to schedule DL data at subframe n+l, wireless network 120 may apply PRB scaling to determine a suitable MCS with the closest or nearest code rate to the reported X. For instance, wireless network 120 may be aware of the CFI value, RS overhead and schedules PRBs at subframe n+l. The number of available REs, Y, may be known. Accordingly, the maximum TBS may be less than X*Y. Additionally, wireless network 120 may be aware of the PRB scaling factor (e.g., the same decision rules may be utilized by wireless network 120 and UE 110). Thus, a suitable MCS may require that the TBS with PRB scaling to be less than X*Y. Wireless network 120 may indicate the MCS and resource allocation (RA) in DCI at subframe n+l. Based on the MCS and RA in DCI, UE 110 may determine the TBS index and TBS size followed by rate de-matching and decoding.

Under current 3GPP specification, base station 125 may enable and disable PRB scaling for PDSCH via DCI. However, the MCS indices with PRB scaling on 6-bit MCS tables are still open. Under a proposed scheme in accordance with the present disclosure, for every MCS with PRB scaling, the modulation orders (Qm or Qm′) and TBS index (I_{TBS}) may form a subset of MCS indices without PRB scaling. Depending on overhead, the base station may dynamically enable and disable PRB scaling. Under the proposed scheme, for each modulation order with PRB scaling, supported I_{TBS} number may be proportional to supported I_{TBS} number of the same Qm-Qm′ combination without PRB scaling and may be rounded. Advantageously, the same scheduling flexibility may be provided whether with or without PRB scaling. Moreover, under the proposed scheme, given the supported I_{TBS} number with PRB scaling, UE 110 may choose I_{TBS} starting from the lowest I_{TBS} of the same index with PRB scaling, with I_{TBS} step size being equal. When encountering high overhead, for large I_{TBS}, base station 125 may adopt the same modulation order with smaller I_{TBS}. However, for the smallest I_{TBS}, such option may not be available. To avoid choosing a different modulation order, the smallest I_{TBS} may have the same target modulation by PRB scaling.

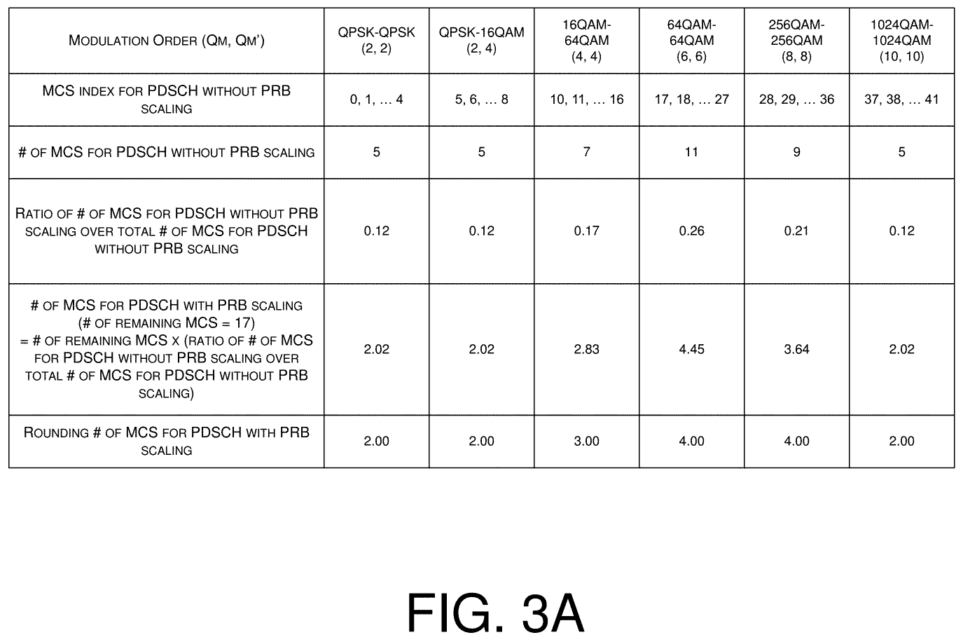

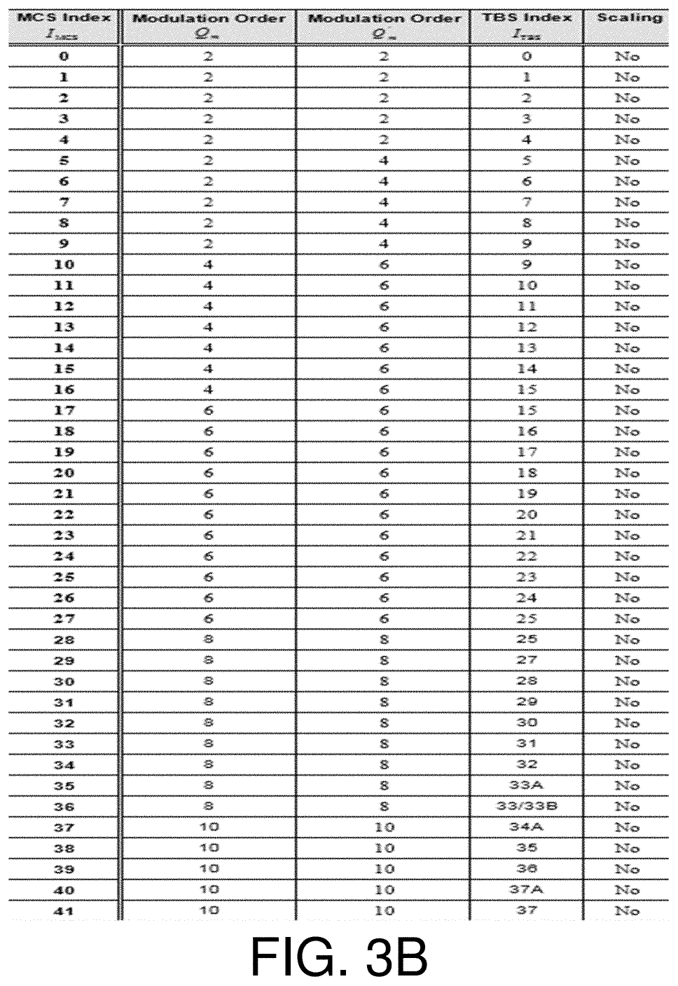

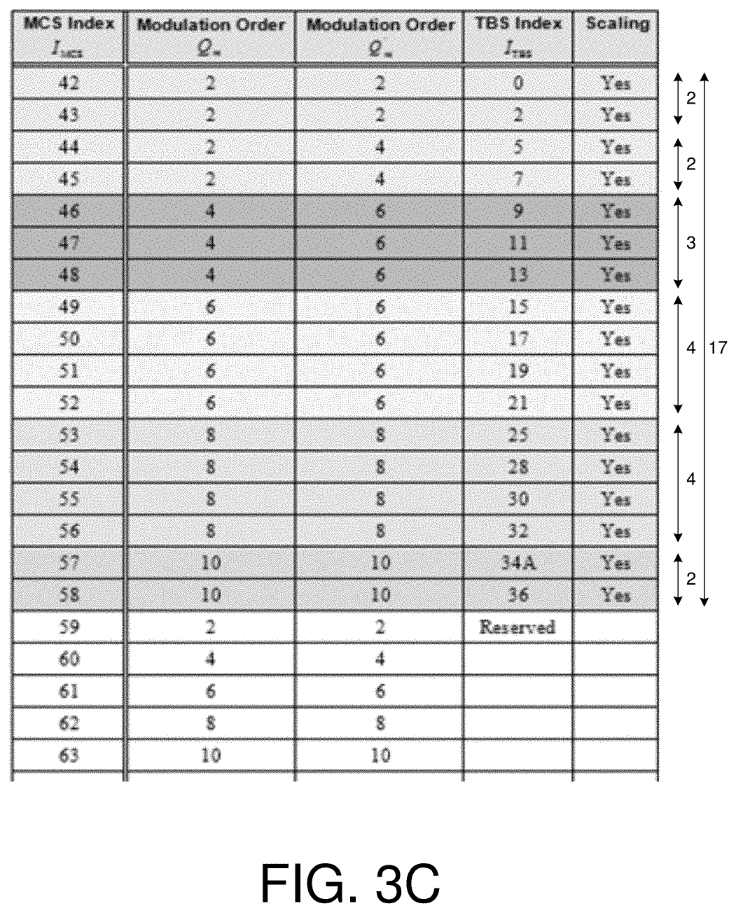

FIGS. 3A, 3B and 3C illustrate tables of an example scenario of an implementation of the proposed scheme with modulations with quadrature phase-shift keying (QPSK) and/or different quadrature amplitude modulations (QAMs), such as 16QAM, 64QAM, 256QAM and 1024QAM, in accordance with the present disclosure. As shown in FIG. 3A and FIG. 3C, for modulation orders of QPSK-QPSK, the rounding number of MCS for PDSCH with PRB scaling is 2, for modulation orders of QPSK-16QAM, the rounding number of MCS for PDSCH with PRB scaling is 2, for modulation orders of 16QAM-64QAM, the rounding number of MCS for PDSCH with PRB scaling is 3, for modulation orders of 64QAM-64QAM, the rounding number of MCS for PDSCH with PRB scaling is 4, for modulation orders of 256QAM-256QAM, the rounding number of MCS for PDSCH with PRB scaling is 4, and for modulation orders of 1024QAM-1024QAM, the rounding number of MCS for PDSCH with PRB scaling is 2. Thus, in this example, the total rounding number of MCS for PDSCH with PRB scaling is 17.

### Illustrative Implementations

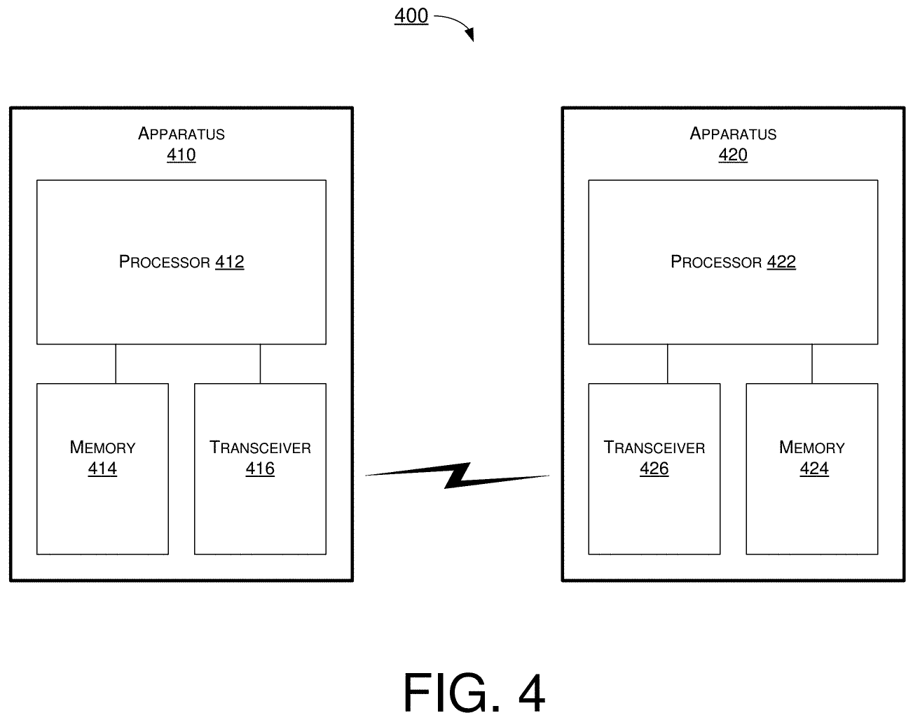

FIG. 4 illustrates an example system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to PRB scaling for data channel with a HARQ process in mobile communications, including the various schemes described above with respect to various proposed designs, concepts, schemes, systems and methods described above as well as process 400 described below. For instance, apparatus 410 may be an example implementation of UE 110, and apparatus 420 may be an example implementation of network node 125.

Each of apparatus 410 and apparatus 420 may be a part of an electronic apparatus, which may be a network apparatus or a UE (e.g., UE 110), such as a portable or mobile apparatus, a wearable apparatus, a wireless communication apparatus or a computing apparatus. For instance, each of apparatus 410 and apparatus 420 may be implemented in a smartphone, a smart watch, a personal digital assistant, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in a network node (e.g., network node 125), such as an eNB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to PRB scaling for data channel with a HARQ process in mobile communications in accordance with various implementations of the present disclosure.

In some implementations, apparatus 410 may also include a transceiver 416 coupled to processor 412. Transceiver 416 may be capable of wirelessly transmitting and receiving data. In some implementations, apparatus 420 may also include a transceiver 426 coupled to processor 422. Transceiver 426 may include a transceiver capable of wirelessly transmitting and receiving data.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE, and apparatus 420, as a base station of a serving cell of a wireless network (e.g., 5G/NR mobile network), is provided below. It is noteworthy that, although the example implementations described below are provided in the context of a UE, the same may be implemented in and performed by a base station. Thus, although the following description of example implementations pertains to apparatus 410 as a UE (e.g., UE 110), the same is also applicable to apparatus 420 as a network node or base station such as a gNB, TRP or eNodeB (e.g., network node 125) of a wireless network (e.g., wireless network 120) such as a 5G NR mobile network.

Under a proposed scheme in accordance with the present disclosure, processor 412 of apparatus 410 may receive, via transceiver 416, RRC signaling from a wireless network (e.g., via apparatus 420) indicating a PRB scaling factor. Additionally, processor 412 may receive, via transceiver 416, a downlink control command from the wireless network indicating whether PRB scaling is enabled or disabled. Moreover, processor 412 may determine a TBS by either: (a) determining the TBS based on the PRB scaling factor and a scheduled PDSCH PRB number indicated in the downlink control command responsive to the PRB scaling being enabled, or (b) determining the TBS based on the schedule PDSCH PRB number responsive to the PRB scaling being disabled. Furthermore, processor 412 may receive, via transceiver 416, a PDSCH according to a result of the determining of the TBS.

In some implementations, in receiving the downlink control command from the wireless network, processor 412 may receive a one-bit field in DCI from the wireless network.

In some implementations, in determining the TBS, processor 412 may determine whether the downlink control command indicates that the PRB scaling is enabled or disabled based on an MCS index in DCI from the wireless network.

In some implementations, the PRB scaling factor may be calculated based on control signaling overhead in a subframe. Alternatively, the PRB scaling factor may be calculated based on one or more predefined rules. Alternatively, the PRB scaling factor may be calculated based on a type of communication indicated by a RNTI type. Alternatively, the PRB scaling factor may be calculated based on a combination of control signaling overhead in a subframe, one or more predefined rules, and a type of communication indicated by a RNTI type.

In some implementations, processor 412 may perform other operations. For instance, processor 412 may receive, via transceiver 416, retransmission of data packets from the wireless network responsive to the PRB scaling being disabled by the downlink control command.

In some implementations, processor 412 may perform other operations. For instance, processor 412 may apply the PRB scaling responsive to the PRB scaling being enabled by the downlink control command. In such cases, the PRB scaling applied by the processor may be based on a calculation similar to that of a PRB scaling applied by the wireless network.

In some implementations, processor 412 may also decode the PDSCH.

Under another proposed scheme in accordance with the present disclosure, processor 412 may receive, via transceiver 416, from a wireless network (e.g., via apparatus 420) an MCS index indicating PRB scaling. Moreover, processor 412 may determine a TBS by choosing a first TBS index. Furthermore, processor 412 may receive, via transceiver 416, a PDSCH according to a result of the determining of the TBS. Additionally, processor 412 may decode the PDSCH.

In some implementations, in determining the TBS, processor 412 may choose the first TBS index from a lowest first TBS index of a same modulation order with PRB scaling and an equal TBS index step.

In some implementations, in determining the TBS, processor 412 may choose the first TBS index from a TBS index of a same modulation order with PRB scaling and any TBS index step. Moreover, the TBS index with PRB scaling may be rounded to a nearest TBS index.

In some implementations, for each modulation order with PRB scaling of a plurality of modulation orders with PRB scaling, a respective TBS index may be proportional to a TBS index of a same modulation order without PRB scaling.

In some implementations, for each MCS index with PRB scaling of a plurality of MCS indices with PRB scaling, a combination of modulation orders and TBS index may form a subset of MCS indices without PRB scaling.

### Illustrative Processes

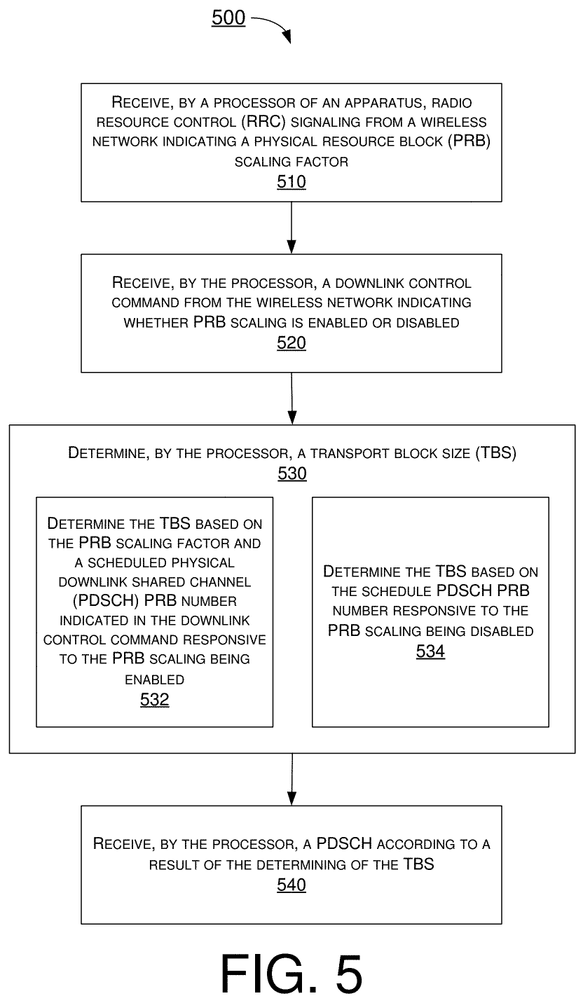

FIG. 5 illustrates an example process 500 in accordance with an implementation of the present disclosure. Process 500 may represent an aspect of implementing various proposed designs, concepts, schemes, systems and methods described above. More specifically, process 500 may represent an aspect of the proposed concepts and schemes pertaining to PRB scaling for data channel with a HARQ process in mobile communications in accordance with the present disclosure. Process 500 may include one or more operations, actions, or functions as illustrated by one or more of blocks 510, 520, 530 and 540 as well as sub-blocks 532 and 534. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed repeatedly or iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a network node (e.g., network node 125) of a wireless network (e.g., wireless network 120) such as a 5G/NR mobile network. Process 500 may begin at block 510.

At 510, process 500 may involve processor 412 of apparatus 410 receiving, via transceiver 416, RRC signaling from a wireless network (e.g., via apparatus 420) indicating a PRB scaling factor. Process 500 may proceed from 510 to 520.

At 520, process 500 may involve processor 412 receiving, via transceiver 416, a downlink control command from the wireless network indicating whether PRB scaling is enabled or disabled. Process 500 may proceed from 520 to 530.

At 530, process 500 may involve processor 412 determining a TBS. In some implementations, in determining the TBS, process 500 may involve processor 412 performing certain operations as represented by 532 and 534. At 532, process 500 may involve processor 412 determining the TBS based on the PRB scaling factor and a scheduled PDSCH PRB number indicated in the downlink control command responsive to the PRB scaling being enabled. At 534, process 500 may involve processor 412 determining the TBS based on the schedule PDSCH PRB number responsive to the PRB scaling being disabled. Process 500 may proceed from 530 to 540.

At 540, process 500 may involve processor 412 receiving, via transceiver 416, a PDSCH according to a result of the determining of the TBS.

In some implementations, in receiving the downlink control command from the wireless network, process 500 may involve processor 412 receiving a one-bit field in DCI from the wireless network.

In some implementations, in determining the TBS, process 500 may involve processor 412 determining whether the downlink control command indicates that the PRB scaling is enabled or disabled based on an MCS index in DCI from the wireless network.

In some implementations, the PRB scaling factor may be calculated based on control signaling overhead in a subframe. Alternatively, the PRB scaling factor may be calculated based on one or more predefined rules. Alternatively, the PRB scaling factor may be calculated based on a type of communication indicated by a RNTI type. Alternatively, the PRB scaling factor may be calculated based on a combination of control signaling overhead in a subframe, one or more predefined rules, and a type of communication indicated by a RNTI type.

In some implementations, process 500 may further involve processor 412 performing other operations. For instance, process 500 may involve processor 412 receiving, via transceiver 416, retransmission of data packets from the wireless network responsive to the PRB scaling being disabled by the downlink control command.

In some implementations, process 500 may further involve processor 412 performing other operations. For instance, process 500 may involve processor 412 applying the PRB scaling responsive to the PRB scaling being enabled by the downlink control command. In such cases, the PRB scaling applied by the processor may be based on a calculation similar to that of a PRB scaling applied by the wireless network.

In some implementations, process 500 may further involve processor 412 performing other operations. For instance, process 500 may involve processor 412 decoding the PDSCH.

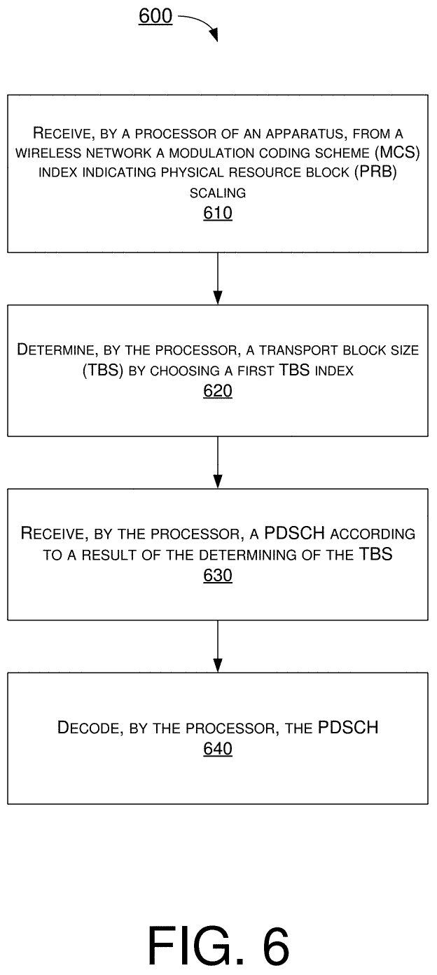

FIG. 6 illustrates an example process 600 in accordance with an implementation of the present disclosure. Process 600 may represent an aspect of implementing various proposed designs, concepts, schemes, systems and methods described above. More specifically, process 600 may represent an aspect of the proposed concepts and schemes pertaining to PRB scaling for data channel with a HARQ process in mobile communications in accordance with the present disclosure. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed repeatedly or iteratively. Process 600 may be implemented by or in apparatus 410 and apparatus 420 as well as any variations thereof. Solely for illustrative purposes and without limiting the scope, process 600 is described below in the context of apparatus 410 as a UE (e.g., UE 110) and apparatus 420 as a network node (e.g., network node 125) of a wireless network (e.g., wireless network 120) such as a 6G/NR mobile network. Process 600 may begin at block 610.

At 610, process 600 may involve processor 412 of apparatus 410 receiving, via transceiver 416, from a wireless network (e.g., via apparatus 420) an MCS index indicating PRB scaling. Process 600 may proceed from 610 to 620.

At 620, process 600 may involve processor 412 determining a TBS by choosing a first TBS index. Process 600 may proceed from 620 to 630.

At 630, process 600 may involve processor 412 receiving, via transceiver 416, a PDSCH according to a result of the determining of the TBS. Process 600 may proceed from 630 to 640.

At 640, process 600 may involve processor 412 decoding the PDSCH.

In some implementations, in determining the TBS, process 600 may involve processor 412 choosing the first TBS index from a lowest first TBS index of a same modulation order with PRB scaling and an equal TBS index step.

In some implementations, in determining the TBS, process 600 may involve processor 412 choosing the first TBS index from a TBS index of a same modulation order with PRB scaling and any TBS index step. Moreover, the TBS index with PRB scaling may be rounded to a nearest TBS index.

In some implementations, for each modulation order with PRB scaling of a plurality of modulation orders with PRB scaling, a respective TBS index may be proportional to a TBS index of a same modulation order without PRB scaling.

In some implementations, for each MCS index with PRB scaling of a plurality of MCS indices with PRB scaling, a combination of modulation orders and TBS index may form a subset of MCS indices without PRB scaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, radio resource control (RRC) signaling from a wireless network indicating a physical resource block (PRB) scaling factor;
receiving, by the processor, a downlink control command from the wireless network indicating whether PRB scaling is enabled or disabled;
determining, by the processor, a transport block size (TBS) by either:
determining the TBS based on the PRB scaling factor and a scheduled physical downlink shared channel (PDSCH) PRB number indicated in the downlink control command responsive to the PRB scaling being enabled, or
determining the TBS based on the schedule PDSCH PRB number responsive to the PRB scaling being disabled; and
receiving, by the processor, a PDSCH according to a result of the determining of the TBS.

2. The method of claim 1, wherein the receiving of the downlink control command from the wireless network comprises receiving a one-bit field in downlink control information (DCI) from the wireless network.

3. The method of claim 1, wherein the determining of the TBS comprises determining whether the downlink control command indicates that the PRB scaling is enabled or disabled based on a modulation coding scheme (MCS) index in downlink control information (DCI) from the wireless network.

4. The method of claim 1, wherein the PRB scaling factor is calculated based on control signaling overhead in a subframe.

5. The method of claim 1, wherein the PRB scaling factor is calculated based on one or more predefined rules.

6. The method of claim 1, wherein the PRB scaling factor is calculated based on a type of communication indicated by a radio network temporary identifier (RNTI) type.

7. The method of claim 1, wherein the PRB scaling factor is calculated based on a combination of control signaling overhead in a subframe, one or more predefined rules, and a type of communication indicated by a radio network temporary identifier (RNTI) type.

8. The method of claim 1, further comprising:
receiving, by the processor, retransmission of data packets from the wireless network responsive to the PRB scaling being disabled by the downlink control command.

9. The method of claim 1, further comprising:
applying, by the processor, the PRB scaling responsive to the PRB scaling being enabled by the downlink control command,
wherein the PRB scaling applied by the processor is based on a calculation similar to that of a PRB scaling applied by the wireless network.

10. The method of claim 1, further comprising:
decoding, by the processor, the PDSCH.

11. A method, comprising:
receiving, by a processor of an apparatus, from a wireless network a modulation coding scheme (MCS) index indicating physical resource block (PRB) scaling; and
determining, by the processor, a transport block size (TBS) by choosing a first TBS index.

12. The method of claim 11, wherein the determining of the TBS comprises choosing the first TBS index from a lowest first TBS index of a same modulation order with PRB scaling and an equal TBS index step.

13. The method of claim 11, wherein the determining of the TBS comprises choosing the first TBS index from a TBS index of a same modulation order with PRB scaling and any TBS index step, and wherein the TBS index with PRB scaling is rounded to a nearest TBS index.

14. The method of claim 11, wherein for each modulation order with PRB scaling of a plurality of modulation orders with PRB scaling, a respective TBS index is proportional to a TBS index of a same modulation order without PRB scaling.

15. The method of claim 11, wherein for each MCS index with PRB scaling of a plurality of MCS indices with PRB scaling, a combination of modulation orders and TBS index form a subset of MCS indices without PRB scaling.

16. An apparatus, comprising:
a transceiver which, during operation, wirelessly communicates with a wireless network; and
a processor coupled to the transceiver such that, during operation, the processor performs operations comprising:
receiving, via the transceiver, radio resource control (RRC) signaling from the wireless network indicating a physical resource block (PRB) scaling factor;
receiving, via the transceiver, a downlink control command from the wireless network indicating whether PRB scaling is enabled or disabled;
determining a transport block size (TBS) by either:
determining the TBS based on the PRB scaling factor and a scheduled physical downlink shared channel (PDSCH) PRB number indicated in the downlink control command responsive to the PRB scaling being enabled, or
determining the TBS based on the schedule PDSCH PRB number responsive to the PRB scaling being disabled; and
receiving, via the transceiver, a PDSCH according to a result of the determining of the TBS.

17. The apparatus of claim 16, wherein, in receiving the downlink control command from the wireless network, the processor receives a one-bit field in downlink control information (DCI) from the wireless network.

18. The apparatus of claim 16, wherein, in determining the TBS, the processor determines whether the downlink control command indicates that the PRB scaling is enabled or disabled based on a modulation coding scheme (MCS) index in downlink control information (DCI) from the wireless network.

19. The apparatus of claim 16, wherein the PRB scaling factor is calculated based on control signaling overhead in a subframe, one or more predefined rules, and a type of communication indicated by a radio network temporary identifier (RNTI) type, or a combination thereof.

20. The apparatus of claim 16, wherein, during operation, the processor further performs operations comprising one or more of:
receiving, via the transceiver, retransmission of data packets from the wireless network responsive to the PRB scaling being disabled by the downlink control command;
applying the PRB scaling responsive to the PRB scaling being enabled by the downlink control command; and
decoding the PDSCH,
wherein the PRB scaling applied by the processor is based on a calculation similar to that of a PRB scaling applied by the wireless network.
